(19) United States
(12) Patent Application Publication
(10) Pub. No.: US 2026/0155313 A1
(43) Pub. Date: Jun. 4, 2026

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/458,103

(22) Filed: Jan. 23, 2026

Related U.S. Application Data
(63) Continuation of application No. PCT/JP2024/023948, filed on Jul. 2, 2024.

(30) Foreign Application Priority Data
Aug. 2, 2023 (JP) 2023-126523

(51) Int. Cl. H01G 4/30; H01G 4/012; H01G 4/232

(52) U.S. Cl. CPC H01G 4/30; H01G 4/012; H01G 4/232

(57) ABSTRACT

In a three-terminal multilayer ceramic capacitor, a dimension LC in a length direction satisfies 0.1 mm≤LC≤0.70 mm or is lower, a dimension WC in a width direction satisfies 0.05 mm≤WC≤0.40 mm or is lower, and a dimension TC in a lamination direction satisfies 0.10 mm≤TC≤0.55 mm or is lower. A side surface lead-out portion includes a base region extending from a side surface facing portion to a side surface and has a dimension in the width direction of W1, and a dimension in the length direction satisfying 10 μm≤L1≤100 μm, and an expansion region in at least one length direction of the base region. When a dimension in the width direction between the side surface and a tip on the side surface side is W2, 0≤W2≤0.9W1 is satisfied.

### CROSS REFERENCE TO RELATED APPLICATIONS

This application claims the benefit of priority to Japanese Patent Application No. 2023-126523 filed on Aug. 2, 2023 and is a Continuation Application of PCT Application No. PCT/JP2024/023948 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Recently, reduction in impedance of electronic circuit lines has become important, particularly for mobile device products. For the purpose of reducing impedance of electronic circuit lines, three-terminal multilayer ceramic capacitors for decoupling applications are widely used.

A three-terminal multilayer ceramic capacitor includes a multilayer body including an inner layer portion in which dielectric layers having end surface internal electrodes exposed at end surfaces thereon and dielectric layers having lateral surface internal electrodes exposed at lateral surfaces thereon are alternately laminated in a plurality of layers, and outer layer portions provided on one side and the other side in the lamination direction of the inner layer portion. The three-terminal multilayer ceramic capacitor further includes end surface external electrodes provided on the end surfaces, and lateral surface external electrodes provided on the lateral surfaces (see Japanese Unexamined Patent Application Publication No. 2013-201417).

Reduction in size of the three-terminal multilayer ceramic capacitor enables further reduction of impedance in high-frequency characteristics. The impedance reduction resulting from reduction in size derives from a decrease in the Equivalent Series Inductance (hereinafter referred to as “ESL”) possessed by the multilayer ceramic capacitor.

### SUMMARY OF THE INVENTION

In recent years, multilayer ceramic capacitors have been increasingly reduced in size.

Example embodiments of the present invention further reduce ESL in each of small-sized three-terminal multilayer ceramic capacitors.

An example embodiment of the present invention provides a three-terminal multilayer ceramic capacitor including a multilayer body including an inner layer portion including a plurality of dielectric layers and a plurality of internal electrodes that are alternately laminated, end surface external electrodes each provided on a corresponding one of both end surfaces of the multilayer body in a length direction intersecting with a lamination direction, and a lateral surface external electrode provided on at least one of lateral surfaces of the multilayer body in a width direction intersecting with the lamination direction and the length direction. The plurality of internal electrodes include end surface exposed internal electrodes each exposed at the end surfaces and connected to the end surface external electrodes, and lateral surface exposed internal electrodes each exposed at a corresponding one of the lateral surfaces and connected to the lateral surface external electrode. Each of the lateral surface exposed internal electrodes includes a lateral surface counter portion opposed to the end surface exposed internal electrodes, and lateral surface extension portions extending from the lateral surface counter portion toward the lateral surfaces. A dimension LC in the length direction satisfies about 0.1 mm≤LC≤about 0.70 mm, a dimension WC in the width direction satisfies about 0.05 mm≤WC≤about 0.40 mm, and a dimension TC in the lamination direction satisfies about 0.10 mm≤TC≤about 0.55 mm. Each of the lateral surface extension portions includes a base region extending from the lateral surface counter portion to one of the lateral surfaces, having a substantially rectangular shape with a dimension W1 in the width direction and a dimension L1 in the length direction satisfying about 10 μm≤L1≤about 100 μm and an extended region provided on at least one side in the length direction of the base region satisfying 0≤W2≤about 0.9W1, where W2 is defined as a dimension in the width direction between a tip of the extended region located adjacent to the lateral surface, and the lateral surface, and satisfying about 0.1L1≤L2≤about 0.4 LL, where L2 is defined as a dimension in the length direction of a portion of the extended region connected to the lateral surface counter portion and LL is defined as a dimension in the length direction of the multilayer body.

According to example embodiments of the present invention, it is possible to further reduce ESL in each of small-sized three-terminal multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1 taken along the II-II direction in FIG. 1 in a first example embodiment of the present invention.

FIG. 3 is a cross-sectional view of the multilayer ceramic capacitor 1 taken along the III-III direction in FIG. 1 in a first example embodiment of the present invention.

FIG. 4 is a cross-sectional view along an end surface exposed internal electrode 15A of the multilayer ceramic capacitor 1.

FIG. 5 is a cross-sectional view along a lateral surface exposed internal electrode 15B of the multilayer ceramic capacitor 1.

FIGS. 6A to 6C each show a modified configuration of an extended region 15Bbk.

FIG. 7 is a diagram explaining a manufacturing process of a multilayer body 2 in a method of manufacturing the multilayer ceramic capacitor 1.

FIG. 8 is a flowchart explaining a method of manufacturing the multilayer ceramic capacitor 1.

### DETAILED DESCRIPTION OF THE EXAMPLE EMBODIMENTS

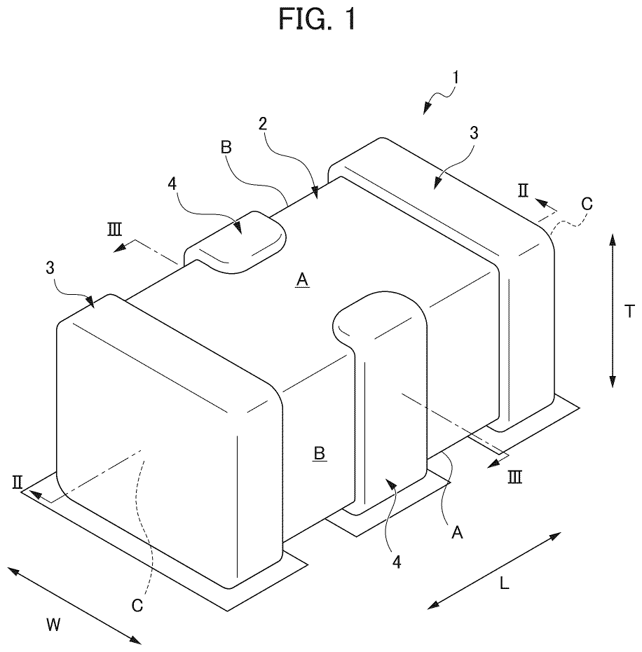

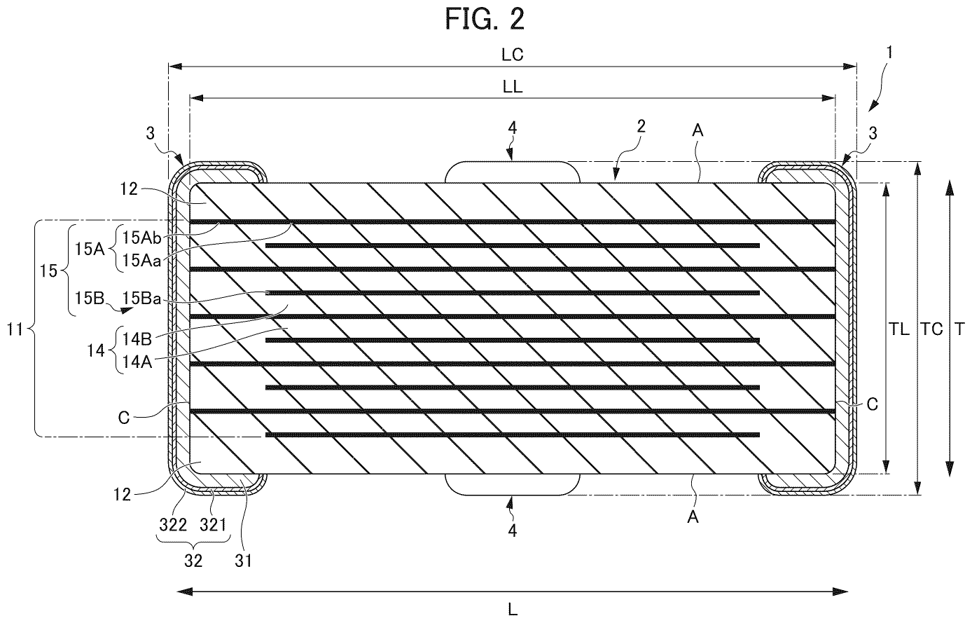

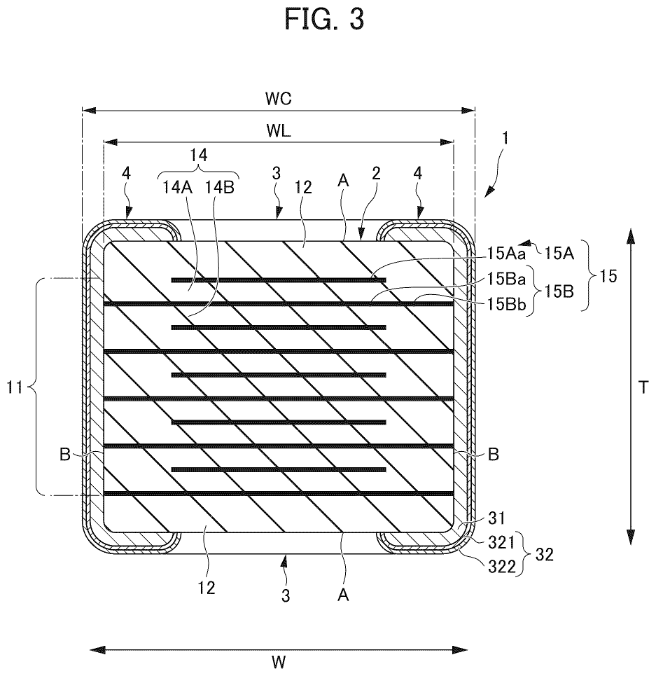

Hereinafter, multilayer ceramic capacitors according to example embodiments of the present invention will be described. FIG. 1 is a schematic perspective view of the multilayer ceramic capacitor 1. FIG. 2 is a cross-sectional view of the multilayer ceramic capacitor 1 taken along the II-II direction in FIG. 1 in a first example embodiment. FIG. 3 is a cross-sectional view of the multilayer ceramic capacitor 1 taken along the III-III direction in FIG. 1 in the first example embodiment.

The multilayer ceramic capacitor 1 is a three-terminal multilayer ceramic capacitor 1 including a multilayer body 2, end surface external electrodes 3 provided on both end surfaces C in the length direction L of the multilayer body 2, and lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C.

The multilayer ceramic capacitor 1 shown in FIG. 2 or FIG. 3 has a dimension LC in the length direction L of about 0.1 mm or more and about 0.70 mm or less, a dimension WC in the width direction W of about 0.05 mm or more and about 0.40 mm or less, and a dimension TC in the lamination direction T of about 0.10 mm or more and about 0.55 mm or less, for example.

Furthermore, the capacitance of the multilayer ceramic capacitor 1 is about 0.022 μF or more and about 10 μF or less, and preferably about 1.0 μF or more and about 2.2 μF or less, for example. The ESL of the multilayer ceramic capacitor 1 is about 65 pH or less at about 100 MHz, and preferably about 50 pH or less at about 1 GHz, for example.

The capacitance of the multilayer ceramic capacitor 1 can be obtained using an LCR meter (available from Agilent Technologies, model number: E4980A) under conditions of 1 kHz and 0.5 Vrms. The ESL of the multilayer ceramic capacitor 1 can be obtained by calculation from measured values of impedance at a predetermined frequency using a network analyzer (available from Agilent Technologies, model number: E5080A).

The multilayer body 2 includes an inner layer portion 11 and outer layer portions 12 provided on both sides of the inner layer portion 11 in the lamination direction T. It is preferable that the multilayer body 2 has rounded corner portions and ridge portions. The corner portions refer to portions where three surfaces of the multilayer body 2 intersect, and the ridge portions refer to portions where two surfaces of the multilayer body 2 intersect.

The dimensions of the multilayer body 2 shown in FIG. 2 or FIG. 3 are as follows: the dimension LL in the length direction L is about 0.09 mm or more and about 0.69 mm or less, the dimension WL in the width direction W is about 0.04 mm or more and about 0.39 mm or less, and the dimension TL in the lamination direction T is about 0.09 mm or more and about 0.54 mm or less, for example.

The inner layer portion 11 includes a plurality of dielectric layers 14 and a plurality of internal electrodes 15 laminated along the lamination direction T.

The dielectric layers 14 are each made of a ceramic material. As the ceramic material, a ceramic material having as a main component a ceramic material including at least one of Ca, Zr, and Ti is used. Specifically, for example, a ceramic material having a perovskite structure represented by a general formula ABO₃ including Ca and Zr is used as a main component. Examples of such ceramic materials having a perovskite structure include, but are not limited to, BaTiO₃ (barium titanate) and CaZrO₃ (calcium zirconate). Further, the main component of the ceramic material forming the dielectric layers 14 may include all of Ca, Zr, and Ti.

The internal electrodes 15 are each preferably made of a metal material such as Ni, Cu, Ag, Pd, Ag—Pd alloy, Au, or the like.

The internal electrodes 15 include a plurality of end surface exposed internal electrodes 15A and a plurality of lateral surface exposed internal electrodes 15B that are alternately provided. When it is not necessary to particularly distinguish between the end surface exposed internal electrodes 15A and the lateral surface exposed internal electrodes 15B, they are collectively described as internal electrodes 15.

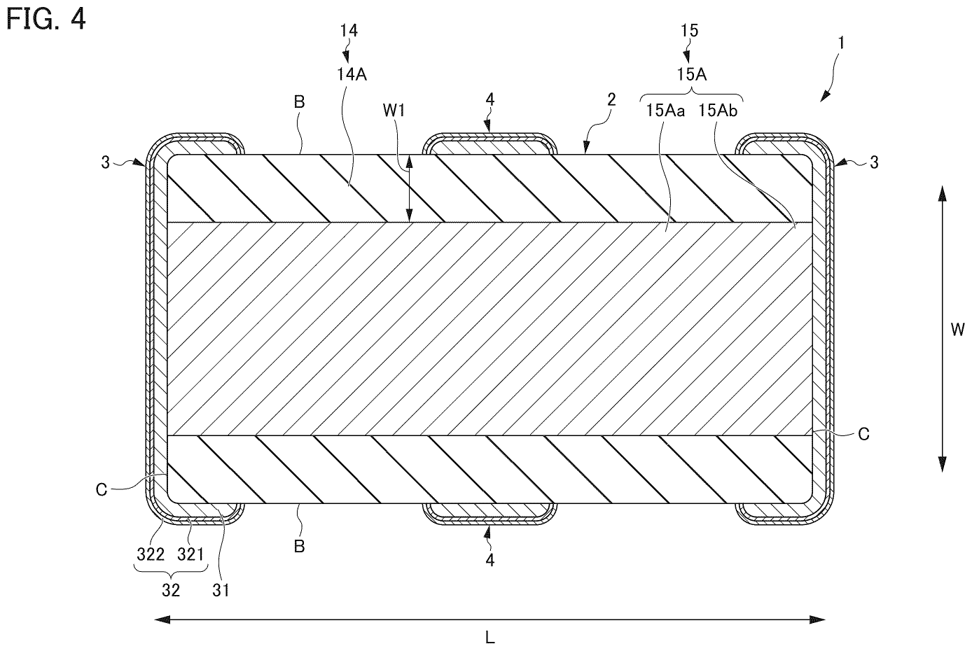

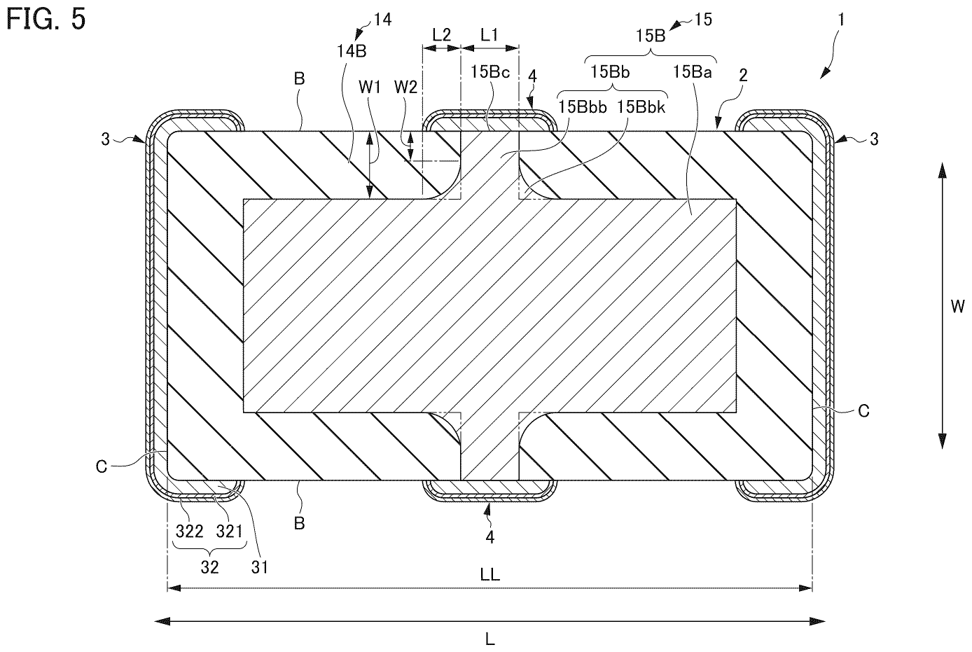

FIG. 4 is a cross-sectional view along the end surface exposed internal electrodes 15A of the multilayer ceramic capacitor 1. FIG. 5 is a cross-sectional view along the lateral surface exposed internal electrodes 15B of the multilayer ceramic capacitor 1.

As shown in FIG. 4, the end surface exposed internal electrode 15A extends between both end surfaces C in the length direction L of the multilayer body 2 and is spaced apart from both lateral surfaces B in the width direction W by a fixed distance W1. The end surface exposed internal electrode 15A includes an end surface counter portion 15Aa located in the middle portion between both end surfaces C, and end surface extension portions 15Ab extending from the end surface counter portion 15Aa toward both end surfaces C. In the example embodiments, the end surface counter portion 15Aa and the end surface extension portions 15Ab have equal dimensions in the width direction W, and the end surface exposed internal electrode 15A is substantially rectangular as a whole combining the end surface counter portion 15Aa and the end surface extension portions 15Ab. The end surface extension portions 15Ab extending from the end surface counter portion 15Aa toward both end surfaces C each extend toward both end surfaces C and are exposed at the end surfaces C of the multilayer body 2, and are connected to the end surface external electrodes 3 provided on both end surfaces C in the length direction L of the multilayer body 2.

As shown in FIG. 5, the lateral surface exposed internal electrode 15B includes a lateral surface counter portion 15Ba located in the middle between both lateral surfaces B, and lateral surface extension portions 15Bb extending from the lateral surface counter portion 15Ba toward both lateral surfaces B. The lateral surface counter portion 15Ba has a substantially rectangular shape that is slightly smaller than the multilayer body 2, and is spaced apart from both lateral surfaces B in the width direction W by a fixed distance W1.

The dimension L1 of the lateral surface extension portions 15Bb in the length direction L is smaller than the dimension of the lateral surface counter portion 15Ba in the length direction L. The lateral surface extension portions 15Bb extend toward both lateral surfaces B and are exposed at the lateral surfaces B of the multilayer body 2, and are bonded to the lateral surface external electrodes 4 provided on both lateral surfaces of the multilayer body 2 in the width direction W.

The end surface counter portion 15Aa and the lateral surface counter portion 15Ba are opposed to each other to provide a capacitor portion.

As shown in FIG. 5, the dimension L1 of the exposed portion 15Bc exposed at the lateral surface B of the lateral surface extension portion 15Bb is about 10 μm≤L1≤about 100 μm, for example.

The lateral surface exposed internal electrode 15B includes a substantially rectangular base region 15Bbb including the exposed portion 15Bc, and an extended region 15Bbk provided in a region including a corner portion between the lateral surface counter portion 15Ba and the base region 15Bbb at least on one side in the length direction L of the base region 15Bbb.

The base region 15Bbb extends from the lateral surface counter portion 15Ba to the lateral surface B, and has a substantially rectangular shape having a dimension W1 in the width direction W and a dimension L1 in the length direction (dimension of the exposed portion 15Bc) that satisfies about 10 μm≤L1≤about 100 μm, for example.

In the example embodiments, the extended regions 15Bbk are provided on both sides of the base region 15Bbb in the length direction L. The shape of each of the extended regions 15Bbk is a shape in which the hypotenuse of a triangle is curved so that the area becomes smaller than that of the triangle. However, the number and shape of the extended regions 15Bbk are not limited to these as long as the dimension in the length direction L of the connection portion with the lateral surface counter portion 15Ba of the entire lateral surface extension portion 15Bb is extended beyond L1 in the case of only the base region 15Bbb.

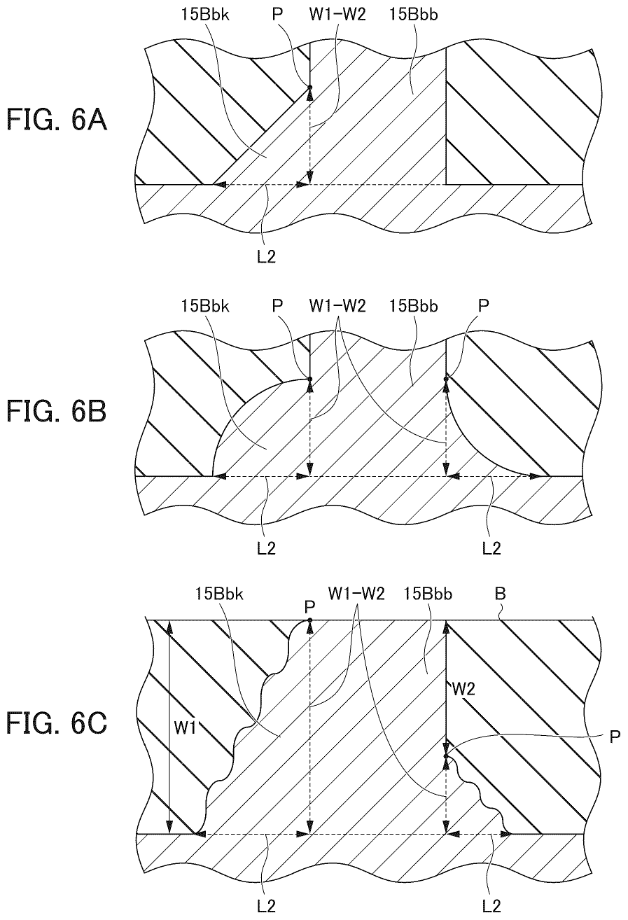

FIGS. 6A, 6B, and 6C are diagrams, each showing a modified configuration of the extended region 15Bbk. The extended region 15Bbk may not be provided on both sides of the base region 15Bbb in the length direction L, and may be provided only on one side of the base region 15Bbb in the length direction L as shown in FIG. 6A.

The extended region 15Bbk may not have a shape in which the contour is curved so that the area becomes smaller than in the case of the substantially triangular shape as described above. For example, the extended region 15Bbk may be in a substantially triangular shape as shown in FIG. 6A. As in the case of the one provided on the left side of FIG. 6B, it may have a contour that is curved so that the area becomes larger than in the case of the substantially triangular shape, for example, a substantially quarter-circular shape or a substantially quarter-elliptical shape. Furthermore, as in the case of the one provided in FIG. 6C, the contour may be in a smooth stepped shape.

When the extended regions 15Bbk are provided on both sides of the base region 15Bbb in the length direction L, the extended regions 15Bbk provided on one side and the other side may have different shapes as in the cases of FIGS. 6B and 6C.

Further, as shown in FIG. 6C, the dimension W2 in the width direction from the tip P located adjacent to the lateral surface B of the extended region 15Bbk to the lateral surface B may be different between the extended regions 15Bbk provided on one side and the other side in the length direction L.

Furthermore, as shown in FIG. 5, when the dimension in the width direction from the tip P located adjacent to the lateral surface B of the extended region 15Bbk to the lateral surface B is defined as W2, in the example embodiments, 0≤W2≤about 0.9W1 is satisfied, for example.

The left side of FIG. 6C shows a case where the extended region 15Bbk is 0=W2, that is, the dimension W1-W2 in the width direction W of the extended region 15Bbk (the length of the extended region 15Bbk) is W1. The right side of FIG. 6C shows a case where the extended region 15Bbk is W2≈0.9W1, that is, the dimension W1-W2 in the width direction W of the extended region 15Bbk (the length of the extended region 15Bbk) is ≈0.1W1, for example.

In this manner, the extended region 15Bbk may have various shapes, but the area of the extended region 15Bbk is smaller than W1×L2 when the dimension in the length direction of the connection portion with the lateral surface counter portion 15Ba is defined as L2 (the width of the extended region 15Bbk). The lateral surface B of the extended region 15Bbk is not exposed at the lateral surface B (or only the point P is exposed). In addition, the extended region 15Bbk preferably has a dimension in the length direction L that gradually decreases from the connection portion with the lateral surface counter portion 15Ba toward the tip P located adjacent to the lateral surface B.

The length direction dimension L2 of the connection portion of the extended region 15Bbk with the lateral surface counter portion 15Ba has the following relationship with respect to the dimension LL in the length direction L of the multilayer body 2 described above and the dimension L1 of each of the exposed portions 15Bc exposed at the lateral surface B of the lateral surface extension portion 15Bb: about 0.1L1≤L2≤about 0.4LL.

The dielectric layers 14 include a plurality of first dielectric layers 14A and a plurality of second dielectric layers 14B which are alternately laminated. The end surface exposed internal electrode 15A exposed at the end surface C is provided on each of the plurality of first dielectric layers 14A, and the lateral surface exposed internal electrode 15B exposed at a portion of the lateral surface B is provided on each of the plurality of second dielectric layers 14B.

With reference to FIG. 2 and FIG. 3 again, each of the outer layer portions 12 is a dielectric layer provided adjacent to the main surface A of the inner layer portion 11. Each of the outer layer portions 12 is made of the same material as the dielectric layers 14 of the inner layer portion 11.

The end surface external electrodes 3 are provided on both end surfaces C of the multilayer body 2. The end surface extension portions 15Ab of the end surface exposed internal electrodes 15A are connected to the end surface external electrodes 3. The end surface external electrodes 3 cover not only the end surfaces C but also portions of the main surfaces A and the lateral surfaces B adjacent to the end surfaces C.

The lateral surface external electrodes 4 are provided on both lateral surfaces B of the multilayer body 2. The lateral surface extension portions 15Bb of the lateral surface exposed internal electrodes 15B are connected to the lateral surface external electrodes 4. The lateral surface external electrodes 4 cover not only the lateral surfaces B but also a portion of the main surfaces A adjacent to the lateral surfaces B.

Each of the end surface external electrodes 3 and each of the lateral surface external electrodes 4 include a base electrode layer 31 and a plated layer 32 provided on the base electrode layer 31. The plated layer 32 includes a Ni (nickel) plated layer 321 provided on the base electrode layer 31 and a Sn (tin) plated layer 322 provided on the Ni plated layer 321. However, example embodiments of the present invention are not limited to such a configuration, and each of the end surface external electrodes 3 and each of the lateral surface external electrodes 4 may have a configuration in which, for example, the base electrode layer 31 is made of Ni, and a Cu plated layer, a Ni plated layer, and a Sn plated layer are sequentially provided thereon.

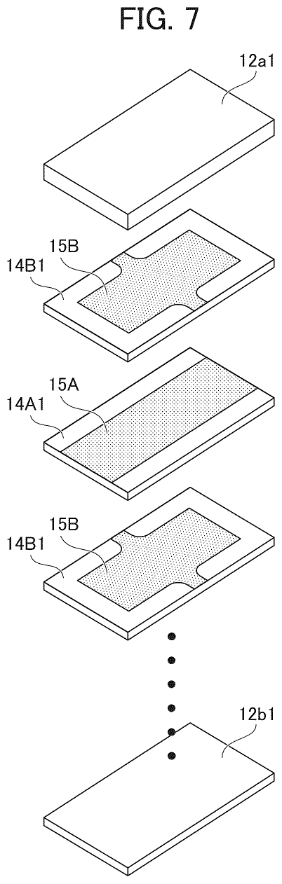

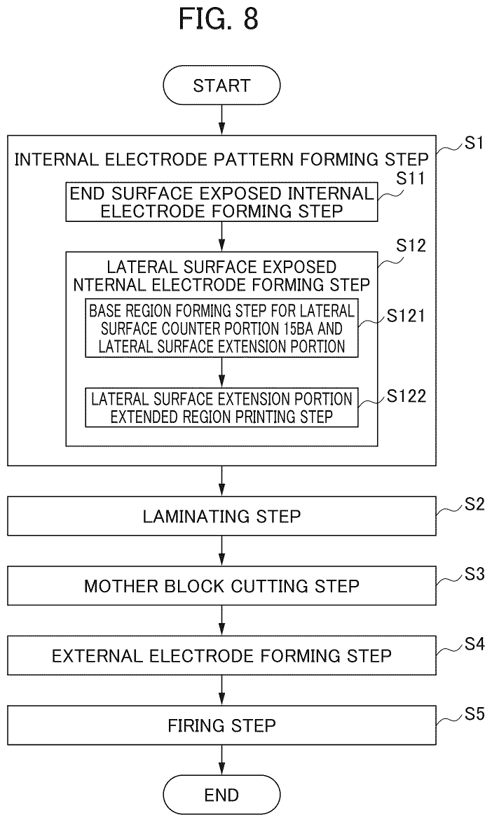

Next, an example of a method of manufacturing the multilayer ceramic capacitors of the example embodiments will be described. FIG. 7 is a diagram explaining the manufacturing steps of the multilayer body 2 in the method of manufacturing the multilayer ceramic capacitor 1. FIG. 8 is a flowchart explaining the method of manufacturing the multilayer ceramic capacitor 1.

The internal electrode pattern forming step S1 includes an end surface exposed internal electrode forming step S11 and a lateral surface exposed internal electrode forming step S12. Either the end surface exposed internal electrode forming step S11 or the lateral surface exposed internal electrode forming step S12 may be performed first.

The end surface exposed internal electrode 15A is formed on a ceramic green sheet 14A1 functioning as the first dielectric layer 14A using an electrically conductive paste.

The ceramic green sheet 14A1 and the ceramic green sheet 14B1 described below are strip-shaped sheets formed by shaping a ceramic slurry including ceramic powder, a binder, and a solvent into a sheet form on a carrier film using a die coater, gravure coater, micro gravure coater, or the like.

The end surface exposed internal electrode 15A, and the base region 15Bbb of the lateral surface counter portion 15Ba and the lateral surface extension portion 15Bb are formed by printing such as screen printing, gravure printing, relief printing, or the like.

Then, the lateral surface exposed internal electrode 15B is formed using electrically conductive paste on the ceramic green sheet 14B1 that functions as the second dielectric layer 14B. The lateral surface exposed internal electrode forming step S12 includes a base region forming step S121 for the lateral surface counter portion 15Ba and the lateral surface extension portion 15Bb, and an extended region printing step S122 for the lateral surface extension portion 15Bb.

Although not limited thereto, the printing of the lateral surface exposed internal electrode 15B, for example, first forms the lateral surface counter portion 15Ba and the base region 15Bbb of the lateral surface extension portion 15Bb.

Next, the extended region 15Bbk of the lateral surface extension portion 15Bb is formed by, for example, inkjet printing.

The ceramic sheets that function as the first dielectric layers 14A on which the end surface exposed internal electrodes 15A are provided and the ceramic sheets that function as the second dielectric layers 14B on which the lateral surface exposed internal electrodes 15B are provided are alternately laminated.

Subsequently, ceramic green sheets for manufacturing the outer layer portions are provided on the upper and lower sides and thermocompression bonded to form a mother block.

Next, the mother block is cut and divided in the length direction L and the width direction W to manufacture a plurality of rectangular parallelepiped multilayer bodies 2.

Next, the lateral surface external electrodes 4 are formed on both lateral surfaces B of the multilayer body 2. The lateral surface extension portions 15Bb of the lateral surface exposed internal electrodes 15B are connected to the lateral surface external electrodes 4. The lateral surface external electrodes 4 are formed to cover not only the lateral surfaces B but also portions of the main surfaces A adjacent to the lateral surfaces B.

Then, end surface external electrodes 3 are formed on both end surfaces C of the multilayer body 2. The end surface extension portions 15Ab of the end surface exposed internal electrodes 15A are connected to the end surface external electrodes 3. The end surface external electrodes 3 are formed to cover not only the end surfaces C but also portions of the main surfaces A and portions of lateral surfaces B adjacent to the end surfaces C.

Then, heating is performed for a predetermined time in a nitrogen atmosphere at a set firing temperature. Thus, the end surface external electrodes 3 and the lateral surface external electrodes 4 are fired on the multilayer body 2 to manufacture the multilayer ceramic capacitor 1 shown in FIG. 1.

As shown in FIG. 5, the dimension L1 of each of the exposed portions 15Bc exposed at the lateral surface B of the lateral surface extension portion 15Bb is about 10 μm≤L1≤about 100 μm, for example.

When the dimension L1 of each of the exposed portions 15Bc is L1<about 10 μm, poor connection between the lateral surface external electrode 4 and the lateral surface exposed internal electrodes 15B may occur, but in the example embodiments, since about 10 μm≤L1 is satisfied, for example, the connection between the lateral surface external electrode 4 and the lateral surface exposed internal electrodes 15B is good.

As described above, the dimension LL of the multilayer body 2 in the length direction L is about 0.69 mm or less, for example. In this case, when the dimension L1 of the exposed portion 15Bc satisfies about 100 μm<L1, the dimension L1 of the exposed portion 15Bc becomes large with respect to the dimension LL of the multilayer body 2. In such a case, since the end surface external electrode 3 also extends around the end surface B, there is a possibility that the extended or wrapped-around portion of the end surface external electrode 3 and the lateral surface external electrode 4 covering the exposed portion 15Bc come into contact with each other. However, in the example embodiments, since L1≤about 100 μm is satisfied, for example, it is possible to reduce the possibility of contact between the lateral surface external electrode 4 and the end surface external electrode 3.

Electric current flowing from the lateral surface external electrode 4 to the lateral surface counter portion 15Ba or from the lateral surface counter portion 15Ba to the lateral surface external electrode 4 passes through the lateral surface extension portion 15Bb.

Unlike the example embodiments, when the extended region 15Bbk is not provided, the lateral surface extension portion 15Bb includes only the base region 15Bbb. The dimension L1 of the base region 15Bbb in the length direction L (dimension in the direction orthogonal to the electric current flow direction) is considerably smaller compared to the dimension LL of the multilayer body 2 in the length direction L. Therefore, it is difficult for electric current to flow from the lateral surface counter portion 15Ba through the lateral surface extension portion 15Bb.

However, in the example embodiments, not only the base region 15Bbb, but also the extended region 15Bbk is included. Therefore, it is possible to increase the dimension in the length direction L (dimension in the direction orthogonal to the electric current flow direction) of the lateral surface extension portion 15Bb continuous from the lateral surface counter portion 15Ba. Thus, electric current flows more easily from the lateral surface counter portion 15Ba to the lateral surface extension portion 15Bb, and it is possible to reduce the ESL of the lateral surface extension portion 15Bb.

Furthermore, as shown in FIG. 5, when a dimension in the width direction from the tip P located adjacent to the lateral surface B of the extended region 15Bbk to the lateral surface B is defined as W2, in the example embodiments, 0≤W2≤about 0.9W1 is satisfied, for example.

Unlike the example embodiments, in the case of about 0.9W1 <W2, the dimension W1-W2 in the width direction W of the extended region 15Bbk (length of the extended region 15Bbk) becomes smaller than about 0.1W1, for example. In such a case, it is not possible to sufficiently obtain the ESL reduction effect by providing the extended region 15Bbk. However, in the example embodiments, since W2≤ about 0.9W1, the dimension in the width direction W of the extended region 15Bbk (W1-W2, length of the extended region 15Bbk) is about 0.1W1 or more, for example. Therefore, it is possible to sufficiently obtain the ESL reduction effect by providing the extended region 15Bbk.

When the length direction dimension of the connection portion with the lateral surface counter portion 15Ba is defined as L2 as shown in FIG. 5, the extended region 15Bbk has the following relationship with respect to the dimension LL in the length direction L of the multilayer body 2 described above and the dimension L1 of the exposed portion 15Bc exposed on the lateral surface B of the lateral surface extension portion 15Bb: about 0.1L1≤L2≤about 0.4LL.

Unlike the example embodiments, when L2< about 0.1L1 is satisfied, that is, when the dimension L2 of the extended region 15Bbk in the length direction L is smaller than about 0.1L1, it is not possible to sufficiently obtain the ESL reduction effect by providing the extended region 15Bbk. However, in the example embodiments, since about 0.1L1≤L2 is satisfied, for example, it is possible to sufficiently obtain the ESL reduction effect by providing the extended region 15Bbk.

In addition, L2≤about 0.4LL is a limitation due to manufacturing difficulty when about 0.4LL<L2, for example.

Although example embodiments of the present invention have been described above, the present invention is not limited to the above-described example embodiments, and various changes and modifications thereto can be made.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including an inner layer portion including a plurality of dielectric layers and a plurality of internal electrodes that are alternately laminated;
end surface external electrodes each provided on a corresponding one of both end surfaces of the multilayer body in a length direction intersecting with a lamination direction; and
a lateral surface external electrode provided on at least one of lateral surfaces of the multilayer body in a width direction intersecting with the lamination direction and the length direction; wherein
the plurality of internal electrodes include:
end surface exposed internal electrodes each exposed at the end surfaces and connected to the end surface external electrodes; and
lateral surface exposed internal electrodes each exposed at a corresponding one of the lateral surfaces and connected to the lateral surface external electrode;
each of the lateral surface exposed internal electrodes includes:
a lateral surface counter portion opposed to the end surface exposed internal electrodes; and
lateral surface extension portions extending from the lateral surface counter portion toward the lateral surfaces;
a dimension LC in the length direction satisfies about 0.1 mm≤LC≤about 0.70 mm;
a dimension WC in the width direction satisfies about 0.05 mm≤WC≤about 0.40 mm; and
a dimension TC in the lamination direction satisfies about 0.10 mm≤TC≤about 0.55 mm; and
each of the lateral surface extension portions includes:
a base region extending from the lateral surface counter portion to one of the lateral surfaces, having a substantially rectangular shape with a dimension W1 in the width direction and a dimension L1 in the length direction satisfying about 10 μm≤L1≤about 100 μm; and
an extending region provided on at least one side in the length direction of the base region, satisfying 0≤W2≤about 0.9W1, where W2 is defined as a dimension in the width direction between a tip of the extended region located adjacent to the lateral surface, and the lateral surface, and satisfying about 0.1L1≤L2≤about 0.4LL, where L2 is defined as a dimension in the length direction of a portion of the extended region connected to the lateral surface counter portion and LL is defined as a dimension in the length direction of the multilayer body.

2. The multilayer ceramic capacitor according to claim 1, wherein the multilayer ceramic capacitor has a capacitance of about 0.222 μF or more and about 10 μF or less.

3. The multilayer ceramic capacitor according to claim 1, wherein the multilayer ceramic capacitor has an equivalent series inductance of about 65 pH or less at about 100 MHz and about 50 pH or less at about 1 GHz.

4. The multilayer ceramic capacitor according to claim 1, wherein an area of the extended region is smaller than W1×L2.

5. The multilayer ceramic capacitor according to claim 1, wherein the extended region has a dimension in the length direction that decreases from the lateral surface counter portion toward a corresponding one of the lateral surfaces.

6. The multilayer ceramic capacitor according to claim 1, wherein the multilayer ceramic capacitor has a capacitance of about 1.0 μF or more and about 2.2 μF or less.

7. The multilayer ceramic capacitor according to claim 1, wherein the multilayer body includes rounded corner portions and ridge portions.

8. The multilayer ceramic capacitor according to claim 1, wherein the multilayer body includes dimensions of about 0.09 mm or more and about 0.69 mm or less in the length direction, about 0.04 mm or more and about 0.39 mm or less in the width direction, and about 0.09 mm or more and about 0.54 mm or less in the lamination direction.

9. The multilayer ceramic capacitor according to claim 1, wherein the plurality of dielectric layers include ceramic material.

10. The multilayer ceramic capacitor according to claim 9, wherein the ceramic material includes at least one of Ca, Zr, or Ti.

11. The multilayer ceramic capacitor according to claim 9, wherein the ceramic material has a perovskite structure including Ca and Zr.

12. The multilayer ceramic capacitor according to claim 9, wherein the ceramic material includes barium titanate and calcium zirconate.

13. The multilayer ceramic capacitor according to claim 9, wherein the ceramic material includes Ca, Zr, and Ti.

14. The multilayer ceramic capacitor according to claim 1, wherein the plurality of internal electrodes include Ni, Cu, Ag, Pd, an Ag—Pd alloy, or Au.

15. The multilayer ceramic capacitor according to claim 1, wherein the extended region is a first extended region on one side in the length direction of the base region, and a second extended region is provided on another side in the length direction of the base region.

16. The multilayer ceramic capacitor according to claim 14, wherein a shape of the first extended region and the second extended region is a shape in which a hypotenuse of a triangle is curved so to have an area smaller than an area of a triangle.

17. The multilayer ceramic capacitor according to claim 1, wherein the extended region is the only extended region and is provided only on the one side in the length direction of the base region.

18. The multilayer ceramic capacitor according to claim 1, wherein the extended region has a substantially triangular shape, a substantially quarter-circular shape, or a substantially quarter-elliptical shape.

19. The multilayer ceramic capacitor according to claim 14, wherein a shape of the first extended region is different from a shape of the second extended region.

20. The multilayer ceramic capacitor according to claim 14, wherein the dimension W2 of the first extended region is different from the dimension W2 of the second extended region.
